(19) United States
(12) Patent Application Publication
(10) Pub. No.: US 2009/0079356 A1
(43) Pub. Date: Mar. 26, 2009

(54) AC/DC LAMP HOLDER

(76) Inventor: Tsung-Yu Yang, Taipei City (TW)

Correspondence Address: PATENTTM.US, P. O. BOX 82788, PORTLAND, OR, 97282-0788, US

(21) Appl. No.: 11/858,774

(22) Filed: Sep. 20, 2007

(51) Int. Cl. H05B 41/16

(52) U.S. Cl. 315/276

(57) ABSTRACT

An AC/CD lamp holder includes a first lamp base having a first end adapted to electrically connect to an AC power source; and an AC/DC transformer having an AC side electrically connected to a second end of the first lamp base opposite to the first end thereof, and a DC side provided with at least one coupling section for electrically connecting with positive and negative electrodes of a DC lighting device. The AC/DC transformer and the first lamp base are formed into one integral body. A DC lighting device can be directly connected to the coupling section of the AC/DC lamp holder to obtain power from a conventional AC power source and provide the illuminating effect. A user needs not to change the whole power supply system or externally connect an AC/DC transformer to the AC power source to thereby save the cost for changing the power supply system.

### FIELD OF THE INVENTION

The present invention relates to an AC/DC lamp holder, and more particularly to a lamp holder that is able to convert alternating current into direct current.

### BACKGROUND OF THE INVENTION

Illumination-related demands and techniques have increasingly grown, and various kinds of lamps have been developed since Thomas Alva Edison invented his first light bulb. In recent years, techniques related to LED have been constantly developed. An LED lamp has the advantages of changeful light emitting manners, prolonged usable lift, and low power consumption, and has gradually replace the position of traditional bulbs.

It is noted, however, conventional household appliances all are powered by an alternating current (AC) power source. When it is desired to use an LED as a light source, a transformer must be externally connected to the conventional AC power source. FIG. 1 shows a conventional lamp using an LED 3 as a light source thereof. An alternating current to direct current (AC/DC) transformer 1 is externally connected to an AC power source 2 in a house to convert the supplied AC power into a DC power, which is then supplied to the LED lamp 3 for the latter to emit light. The AC/DC transformer 1 usually has a quite big volume, and the LED lamp 3 can not be directly connected to an existing lamp holder in the house.

It is therefore tried by the inventor to develop an AC/DC lamp holder, which allows the use of a conventional AC lamp socket to lighten a DC lighting device without the need of expending money to change the whole power supply system or externally connect an AC/DC transformer to the AC power source.

### SUMMARY OF THE INVENTION

A primary object of the present invention is to provide an AC/DC lamp holder that allows a user to use a conventional AC lamp socket to lighten a DC lighting device without the need of expending money to change the whole power supply system or externally connect an AC/DC transformer to the AC power source.

To achieve the above and other objects, the AC/DC lamp holder according to the present invention includes a first lamp base having a first end adapted to electrically connect to an AC power source; and an AC/DC transformer having an AC side electrically connected to a second end of the first lamp base opposite to the first end thereof, and a DC side provided with at least one coupling section for electrically connecting with positive and negative electrodes of a DC lighting device. The AC/DC transformer and the first lamp base are formed into one integral body.

A DC lighting device can be directly connected to the coupling section of the AC/DC lamp holder to obtain power from a conventional AC power source and provide the illuminating effect. A user needs not to expend money to change the whole in-house power supply system or externally connect an AC/DC transformer to the AC power source.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional lamp using an LED as a light source thereof;

FIG. 2 is a vertical sectional view of an AC/DC lamp holder according to a first preferred embodiment of the present invention;

FIG. 3 is a perspective view of the AC/DC lamp holder of FIG. 2;

FIG. 4 is a vertical sectional view of an AC/DC lamp holder according to a second preferred embodiment of the present invention;

FIG. 5 is a perspective view of the AC/DC lamp holder of FIG. 4;

FIG. 6 is a vertical sectional view of an AC/DC lamp holder according to a third preferred embodiment of the present invention;

FIG. 7 is a perspective view of the AC/DC lamp holder of FIG. 6;

FIG. 8 is a vertical sectional view of an AC/DC lamp holder according to a fourth preferred embodiment of the present invention;

FIG. 9 is a perspective view of the AC/DC lamp holder of FIG. 8;

FIG. 10 is a vertical sectional view of an AC/DC lamp holder according to a fifth preferred embodiment of the present invention;

FIG. 11 is a perspective view of the AC/DC lamp holder of FIG. 10;

FIG. 12 is a vertical sectional view of an AC/DC lamp holder according to a sixth preferred embodiment of the present invention;

FIG. 13 is a perspective view of the AC/DC lamp holder of FIG. 12;

FIG. 14 is a vertical sectional view of an AC/DC lamp holder according to a seventh preferred embodiment of the present invention;

FIG. 15 is a perspective view of the AC/DC lamp holder of FIG. 14;

FIG. 16 is a vertical sectional view of an AC/DC lamp holder according to an eighth preferred embodiment of the present invention;

FIG. 17 is a perspective view of the AC/DC lamp holder of FIG. 16;

FIG. 18 is a vertical sectional view of an AC/DC lamp holder according to a ninth preferred embodiment of the present invention; and

FIG. 19 is a perspective view of the AC/DC lamp holder of FIG. 18.

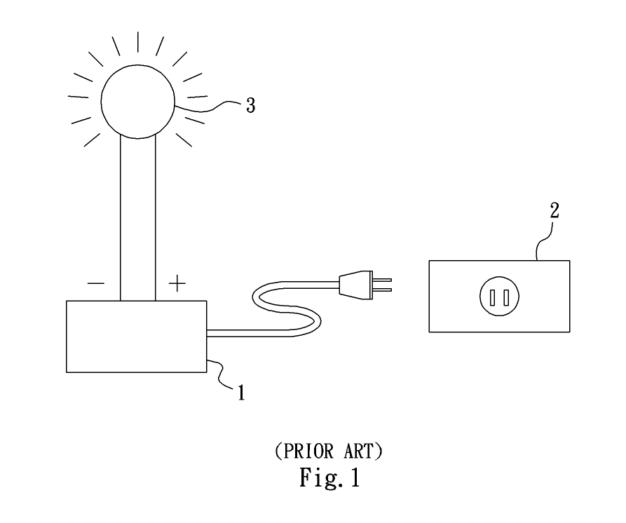

### DETAILED DESCRIPTION OF THE PREFERRED EMBODIMENTS

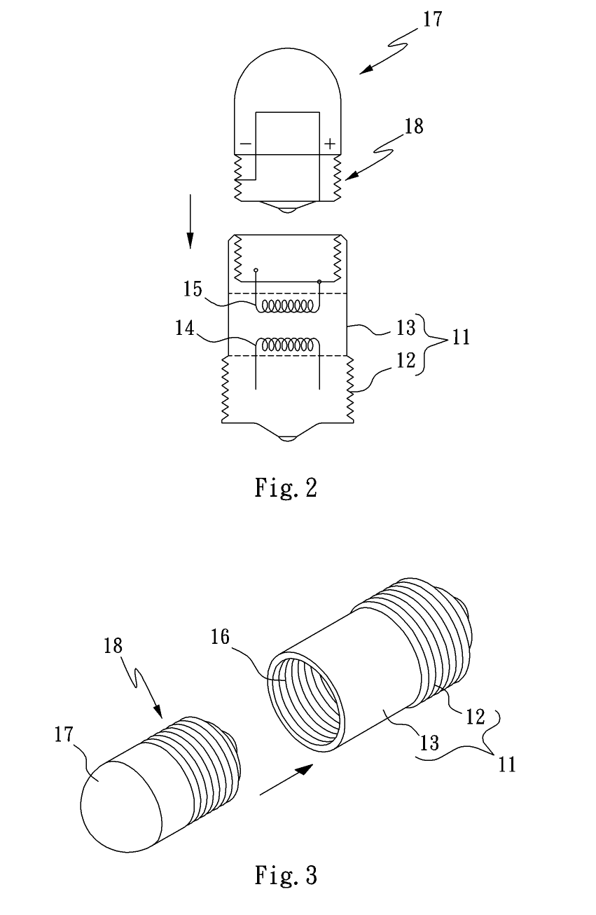

Please refer to FIGS. 2 and 3 that are vertical sectional and perspective views, respectively, of an AC/DC lamp holder 11 according to a first preferred embodiment of the present invention. As shown, the AC/DC lamp holder 11 includes a first lamp base 12, which is a screw base in the illustrated first embodiment, having a first end for electrically connecting to an AC power supply (not shown); and an AC/DC transformer 13 having an AC side 14 electrically connected to a second end of the first lamp base 12 opposite to the first end thereof, and a DC side 15 provided with a coupling section 16, which is an internally threaded socket in the illustrated first embodiment, for electrically connecting with positive and negative electrodes of a DC lighting device 17, which includes, but not limited to, an LED lamp. The AC/DC transformer 13 and the first lamp base 12 are integrally formed into one body. The DC lighting device 17 includes a second lamp base 18, which is a screw base in the illustrated first embodiment corresponding to the internally threaded socket at the coupling section 16.

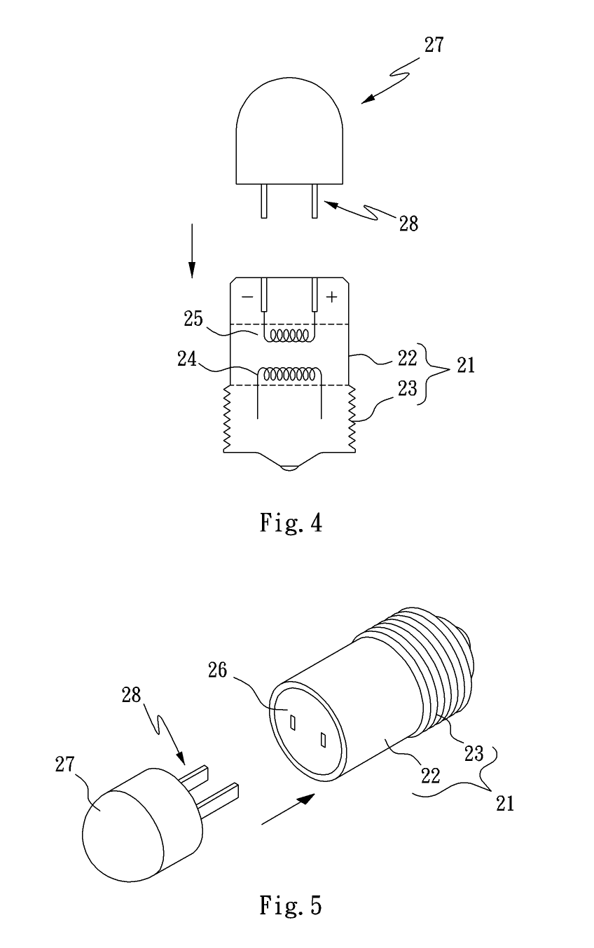

FIGS. 4 and 5 are vertical sectional and perspective views, respectively, of an AC/DC lamp holder 21 according to a second preferred embodiment of the present invention. As shown, the AC/DC lamp holder 21 includes a first lamp base 22, which is a screw base in the illustrated second embodiment, having a first end for electrically connecting to an AC power supply (not shown); and an AC/DC transformer 23 having an AC side 24 electrically connected to a second end of the first lamp base 22 opposite to the first end thereof, and a DC side 25 provided with at least one coupling section 26, which is a receptacle in the illustrated second embodiment, for electrically connecting with positive and negative electrodes of a DC lighting device 27, which includes, but not limited to, an LED lamp. The AC/DC transformer 23 and the first lamp base 22 are integrally formed into one body. The DC lighting device 27 includes a second lamp base 28, which is a plug-type base in the illustrated second embodiment corresponding to the receptacle at the coupling section 26.

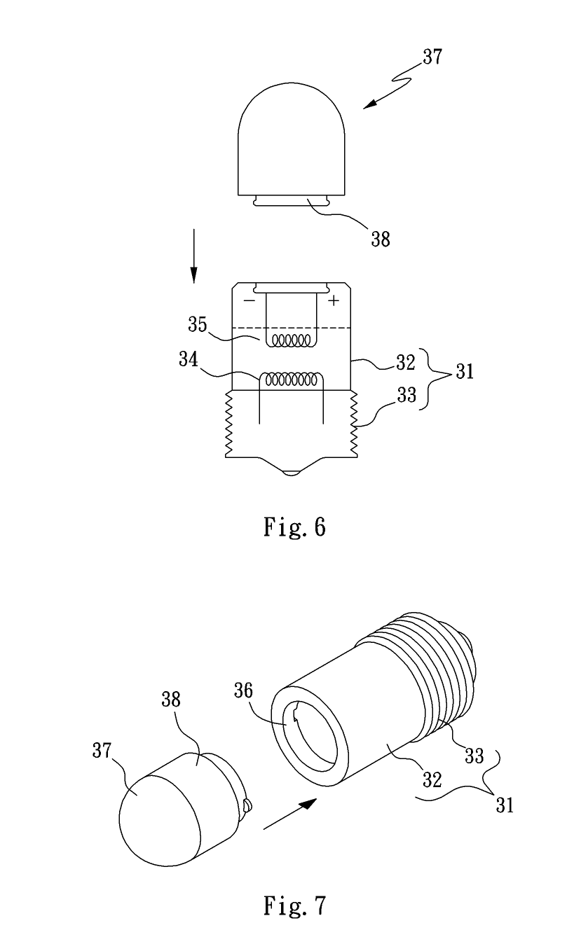

FIGS. 6 and 7 are vertical sectional and perspective views, respectively, of an AC/DC lamp holder 31 according to a third preferred embodiment of the present invention. As shown, the AC/DC lamp holder 31 includes a first lamp base 32, which is a screw base in the illustrated third embodiment, having a first end for electrically connecting to an AC power supply (not shown); and an AC/DC transformer 33 having an AC side 34 electrically connected to a second end of the first lamp base 32 opposite to the first end thereof, and a DC side 35 provided with at least one coupling section 36, which is a bayonet socket in the illustrated third embodiment, for electrically connecting with positive and negative electrodes of a DC lighting device 37, which includes, but not limited to, an LED lamp. The AC/DC transformer 33 and the first lamp base 32 are integrally formed into one body. The DC lighting device 37 includes a second lamp base 38, which is a bayonet base in the illustrated third embodiment corresponding to the bayonet socket at the coupling section 36.

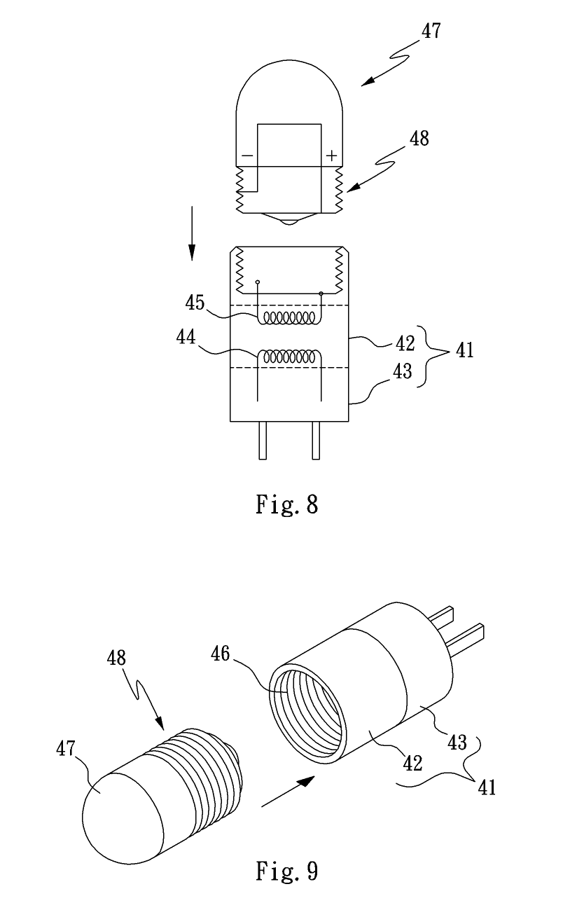

FIGS. 8 and 9 are vertical sectional and perspective views, respectively, of an AC/DC lamp holder 41 according to a fourth preferred embodiment of the present invention. As shown, the AC/DC lamp holder 41 includes a first lamp base 42, which is a plug-type base in the illustrated fourth embodiment, having a first end for electrically connecting to an AC power supply (not shown); and an AC/DC transformer 43 having an AC side 44 electrically connected to a second end of the first lamp base 42 opposite to the first end thereof, and a DC side 45 provided with at least one coupling section 46, which is an internally threaded socket in the illustrated fourth embodiment, for electrically connecting with positive and negative electrodes of a DC lighting device 47, which includes, but not limited to, an LED lamp. The AC/DC transformer 43 and the first lamp base 42 are integrally formed into one body. The DC lighting device 47 includes a second lamp base 48, which is a screw base in the illustrated fourth embodiment corresponding to the internally threaded socket at the coupling section 46.

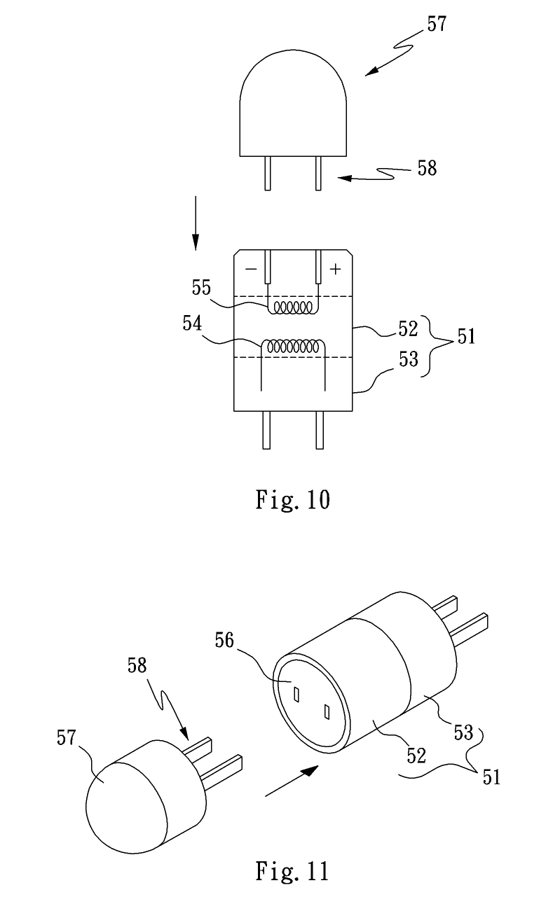

FIGS. 10 and 11 are vertical sectional and perspective views, respectively, of an AC/DC lamp holder 51 according to a fifth preferred embodiment of the present invention. As shown, the AC/DC lamp holder 51 includes a first lamp base 52, which is a plug-type base in the illustrated fifth embodiment, having a first end for electrically connecting to an AC power supply (not shown); and an AC/DC transformer 53 having an AC side 54 electrically connected to a second end of the first lamp base 52 opposite to the first end thereof, and a DC side 55 provided with at least one coupling section 56, which is a receptacle in the illustrated fifth embodiment, for electrically connecting with positive and negative electrodes of a DC lighting device 57, which includes, but not limited to, an LED lamp. The AC/DC transformer 53 and the first lamp base 52 are integrally formed into one body. The DC lighting device 57 includes a second lamp base 58, which is a plug-type base in the illustrated fifth embodiment corresponding to the receptacle at the coupling section 56.

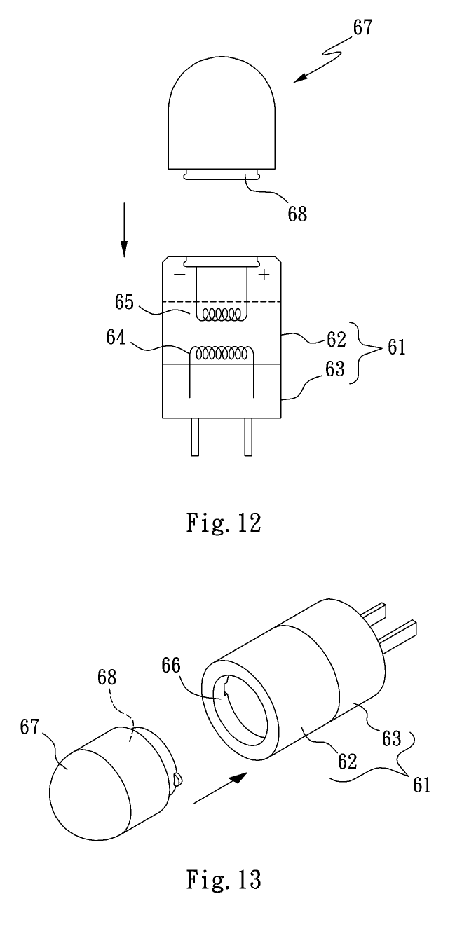

FIGS. 12 and 13 are vertical sectional and perspective views, respectively, of an AC/DC lamp holder 61 according to a sixth preferred embodiment of the present invention. As shown, the AC/DC lamp holder 61 includes a first lamp base 62, which is a plug-type base in the illustrated sixth embodiment, having a first end for electrically connecting to an AC power supply (not shown); and an AC/DC transformer 63 having an AC side 64 electrically connected to a second end of the first lamp base 62 opposite to the first end thereof, and a DC side 65 provided with at least one coupling section 66, which is a bayonet socket in the illustrated sixth embodiment, for electrically connecting with positive and negative electrodes of a DC lighting device 67, which includes, but not limited to, an LED lamp. The AC/DC transformer 63 and the first lamp base 62 are integrally formed into one body. The DC lighting device 67 includes a second lamp base 68, which is a bayonet base in the illustrated sixth embodiment corresponding to the bayonet socket at the coupling section 66.

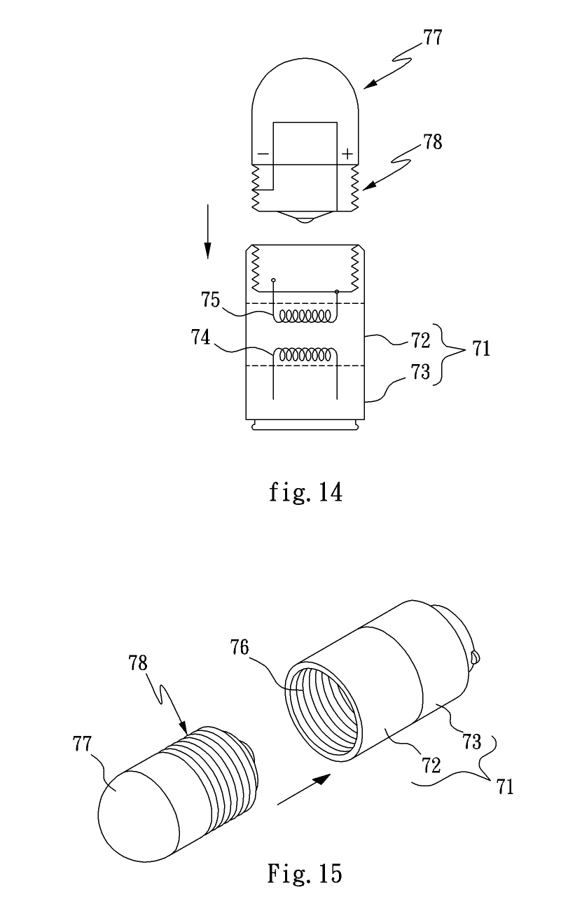

FIGS. 14 and 15 are vertical sectional and perspective views, respectively, of an AC/DC lamp holder 71 according to a seventh preferred embodiment of the present invention. As shown, the AC/DC lamp holder 71 includes a first lamp base 72, which is a bayonet base in the illustrated sixth embodiment, having a first end for electrically connecting to an AC power supply (not shown); and an AC/DC transformer 73 having an AC side 74 electrically connected to a second end of the first lamp base 72 opposite to the first end thereof, and a DC side 75 provided with at least one coupling section 76, which is an internally threaded socket in the illustrated seventh embodiment, for electrically connecting with positive and negative electrodes of a DC lighting device 77, which includes, but not limited to, an LED lamp. The AC/DC transformer 73 and the first lamp base 72 are integrally formed into one body. The DC lighting device 77 includes a second lamp base 78, which is a screw base in the illustrated seventh embodiment corresponding to the internally threaded socket at the coupling section 76.

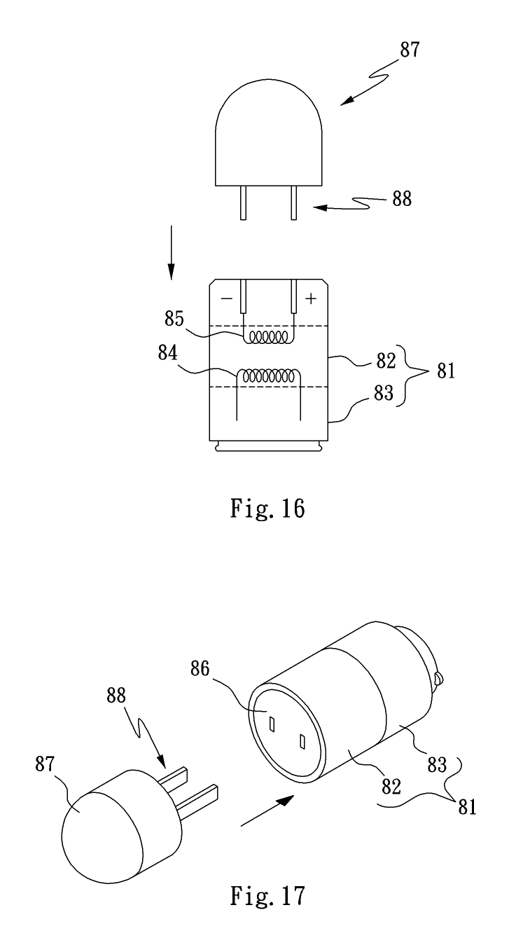

FIGS. 16 and 17 are vertical sectional and perspective views, respectively, of an AC/DC lamp holder 81 according to an eighth preferred embodiment of the present invention. As shown, the AC/DC lamp holder 81 includes a first lamp base 82, which is a bayonet base in the illustrated eighth embodiment, having a first end for electrically connecting to an AC power supply (not shown); and an AC/DC transformer 83 having an AC side 84 electrically connected to a second end of the first lamp base 82 opposite to the first end thereof, and a DC side 85 provided with at least one coupling section 86, which is a receptacle in the illustrated eighth embodiment, for electrically connecting with positive and negative electrodes of a DC lighting device 87, which includes, but not limited to, an LED lamp. The AC/DC transformer 83 and the first lamp base 82 are integrally formed into one body. The DC lighting device 87 includes a second lamp base 88, which is a plug-type base in the illustrated eighth embodiment corresponding to the receptacle at the coupling section 86.

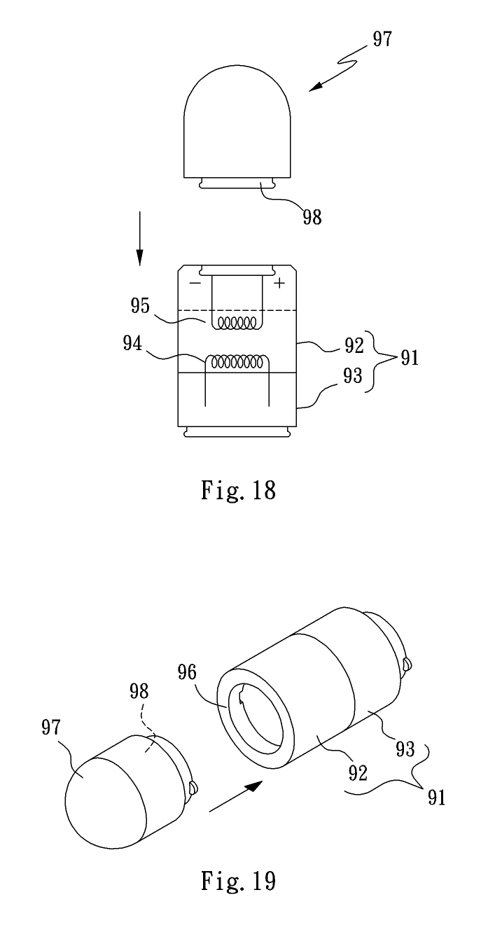

FIGS. 18 and 19 are vertical sectional and perspective views, respectively, of an AC/DC lamp holder 91 according to a ninth preferred embodiment of the present invention. As shown, the AC/DC lamp holder 91 includes a first lamp base 92, which is a bayonet base in the illustrated eighth embodiment, having a first end for electrically connecting to an AC power supply (not shown); and an AC/DC transformer 93 having an AC side 94 electrically connected to a second end of the first lamp base 92 opposite to the first end thereof, and a DC side 95 provided with at least one coupling section 96, which is a bayonet socket in the illustrated ninth embodiment, for electrically connecting with positive and negative electrodes of a DC lighting device 97, which includes, but not limited to, an LED lamp. The AC/DC transformer 93 and the first lamp base 92 are integrally formed into one body. The DC lighting device 97 includes a second lamp base 98, which is a bayonet base in the illustrated ninth embodiment corresponding to the bayonet socket at the coupling section 96.

The AC/DC lamp holder of the present invention allows a DC lighting device to be directly mounted thereto to obtain power from a conventional AC power source and provide the illuminating effect, and a user needs not to change the whole power supply system or externally connect an AC/DC transformer to the AC power source. Therefore, the cost for changing the power supply system can be saved and the DC lighting device is more convenient and practical for use to meet the market demands.

What is claimed is:

1. An AC/DC lamp holder, comprising:
a first lamp base having a first end adapted to electrically connect to an AC power source; and
an AC/DC transformer having an AC side electrically connected to a second end of the first lamp base opposite to the first end thereof, and a DC side provided with at least one coupling section for electrically connecting with positive and negative electrodes of a DC lighting device; and
wherein the AC/DC transformer and the first lamp base are formed into one integral body.

2. The AC/DC lamp holder as claimed in claim 1, wherein the first lamp base is selected from the group consisting of a screw base, a plug-type base, and a bayonet base.

3. The AC/DC lamp holder as claimed in claim 1, wherein the DC lighting device is an LED.

4. The AC/DC lamp holder as claimed in claim 1, wherein the coupling section is selected from the group consisting of an internally threaded socket, a receptacle, and a bayonet socket.

5. The AC/DC lamp holder as claimed in claim 4, wherein the DC lighting device includes a second lamp base.

6. The AC/DC lamp holder as claimed in claim 5, wherein the second lamp base is selected from the group consisting of a screw base, a plug-type base, and a bayonet base.
